(19) United States
(12) Patent Application Publication
(10) Pub. No.: US 2016/0338364 A1
(43) Pub. Date: Nov. 24, 2016

(54) Bread Boring Tool

(71) Applicant: Anthony Jeffery, Elsmere, DE (US)

(72) Inventor: Anthony Jeffery, Elsmere, DE (US)

(21) Appl. No.: 15/161,065

(22) Filed: May 20, 2016

Related U.S. Application Data
(60) Provisional application No. 62/164,290, filed on May 20, 2015.

(51) Int. Cl. A21C 15/00; A47G 21/04; B23B 45/06

(52) U.S. Cl. CPC A21C 15/007; B23B 45/06; A47G 21/04

(57) ABSTRACT

A bread boring tool for boring channels into the center of food items, such as a loaf of bread, in order to enable the filling or stuffing thereof. The bread boring tool includes an elongated rod having a first end and a second end, wherein the first end includes a pointed tip and the second end includes a scooper. The elongated rod further includes a helical thread axially disposed around the rod, and extending longitudinally therearound towards the first end. The helical thread includes a pointed end terminating at the pointed tip of the first end such that it is symmetrically aligned with the pointed tip of the elongated rod. In this way, a user may utilize both the pointed tip of the elongated rod and the pointed end of the helical thread to puncture the food item at two separate locations to facilitate the boring thereof.

### CROSS REFERENCE TO RELATED APPLICATIONS

This application claims the benefit of U.S. Provisional Application No. 62/164,290 filed on May 20, 2015. The above identified patent application is herein incorporated by reference in its entirety to provide continuity of disclosure.

### BACKGROUND OF THE INVENTION

The present invention relates to kitchen utensils. Specifically, it relates to a bread boring tool for boring channels into a food item, such as a loaf of bread, in order to enable the filling and/or stuffing thereof.

Many individuals enjoy making and eating sandwiches. Sandwiches are made virtually in every household in the world. For example, parents make sandwiches for their children for lunch, as a snack, and sometimes even for dinner. Moreover, individuals often make sandwiches for themselves or others to take for lunch at work. Sandwiches are made with many different types of ingredients ranging from cheese, cold cuts, steaks, cutlets, vegetables, and condiments. In order to properly make a sandwich, a user slices their own bread or uses sliced bread. The sliced bread makes it easy for an individual to sandwich the ingredients in between two pieces of sliced bread. However, eating sandwiches having two pieces of sliced bread can be messy and unenjoyable because a lot of the time the ingredients packed therebetween slide out. Moreover, there is no kitchen utensil tool that facilitates in the making of a sandwich other than a knife. Thus, there is a need for a kitchen utensil that enables an individual to burrow a hole in a piece of bread enabling him or her to stuff the bread with a variety of ingredients, thereby creating a sandwich in which the ingredients are contained

### SUMMARY OF THE INVENTION

In view of the foregoing disadvantages inherent in the known types of kitchen utensils now present in the prior art, the present invention provides a bread boring tool wherein the same can be utilized for providing convenience for the user when making sandwiches. The present system provides a bread boring tool including an elongated rod having a first end and a second end, a pointed tip disposed on the first end, a scooper disposed on the second end, and a helical thread axially disposed around an exterior of the elongated rod, wherein the helical thread includes a spur.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a top plan view of the bread boring tool.

FIG. 2 shows a side view of the bread boring tool.

FIG. 3 shows a close-up view of the pointed end of the helical thread.

FIG. 4 shows a perspective view of the bread boring tool in use to bore out a hole from a loaf of bread.

### DETAILED DESCRIPTION OF THE INVENTION

Reference is made herein to the attached drawings. Like reference numerals are used throughout the drawings to depict like or similar elements of the bread boring tool. The figures are intended for representative purposes only and should not be considered to be limiting in any respect.

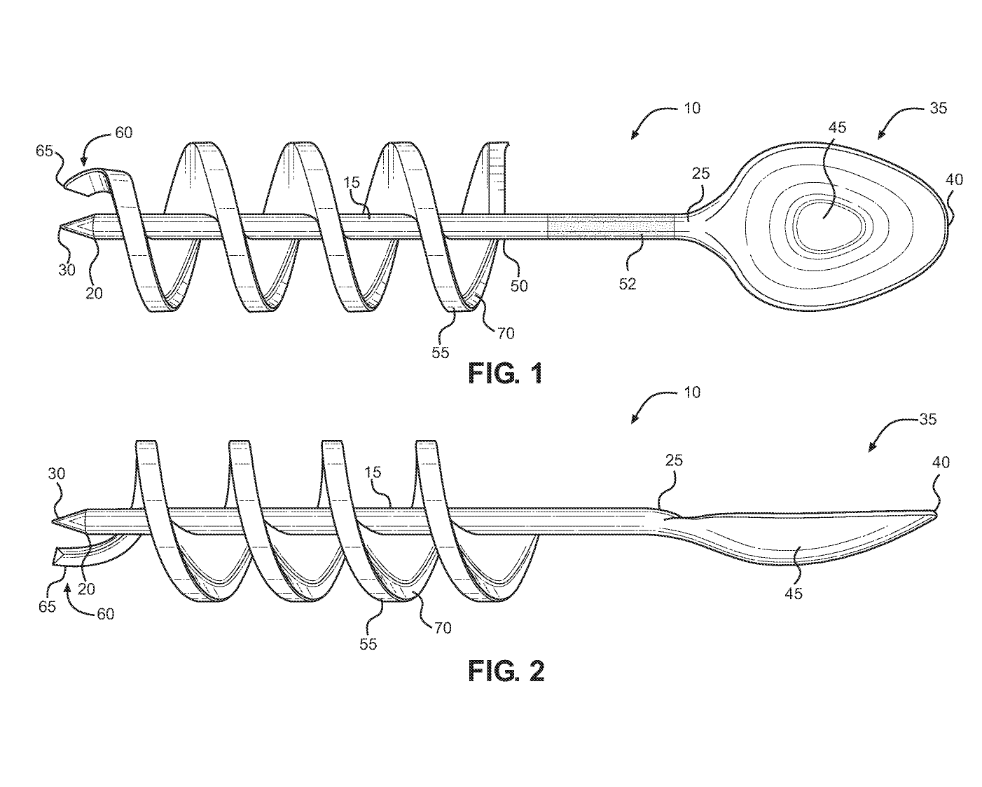

Referring now to FIGS. 1 and 2, there are shown views of the bread boring tool. The bread boring tool 10 facilitates the boring of hollowed channels into the interior of food items, such as a loaf of bread, such that an individual may fill or stuff the interior of the food item with a desired ingredient. The bread boring tool 10 comprises an elongated rod 15 having a first end 20 and a second end 25, wherein the first end 20 comprises a pointed tip 30 and the second end 25 comprises a scooper 35. The pointed tip 30 is configured to piece a hole in a food item such that it may penetrate the food item's interior. In one embodiment, the pointed tip 30 is elongated and comprises a sharpened edge such that it may puncture and penetrate harder food items. In another embodiment, the pointed tip 30 comprises a blunted tip. The elongated rod 15 may be composed of a metal or plastic material, such as stainless steel, aluminum, polycarbonate, or polyvinyl chloride.

The scooper 35 comprises a bowl 40 having a reservoir 45 configured to scoop out food from food items and/or receive them therein. In one embodiment, the scooper 35 comprises a quick release mechanism, wherein the mechanism comprises an actuator operably coupled to a lever disposed in the reservoir that ejects food from the reservoir in response to the actuator being triggered, thereby facilitating the stuffing of food items with sticky foods, such as condiments like ketchup and or mustard. In another embodiment, the scooper 35 is shaped like a spoon. In an alternative embodiment, the scooper 35 further serves as a handle when utilizing the bread boring tool 10 to bore a hole into a food item. In yet another embodiment, the elongated rod 15 further comprises a middle portion 50 disposed in between the first end 20 and the second end 25, wherein the middle portion 50 includes a grip 52 having a tacky material for grasping the bread boring tool 10 to aid in rotating it.

The bread boring tool 10 further comprises a helical thread 55 or worm that is axially disposed around the elongated rod 15, such that the elongated rod 15 runs through the center of the helical thread 55. The helical thread 55 extends longitudinally around the elongated rod 15 from approximately the center thereof towards the first end 20, wherein the helical thread 55 terminates at pointed tip 30 of the first end 20.

The helical thread 55 enables boring because by turning the helical thread 55 into a food item, the rotational motion undergone by the helical thread 55 translates to a linear directional force that is applied to the food item. In one embodiment, the helical thread 55 comprises a raised edge 70 disposed on the perimeter of the thread and extending therealong, wherein the edge 70 faces upwardly and tapers towards the elongated rod 15. The edge 70 is configured to secure the food stuff being bored out of a food item on the helical thread 55, such that when the bread boring tool 10 is removed from the food item, the thread 55 captures the food stuff and removes it from the interior of the food item.

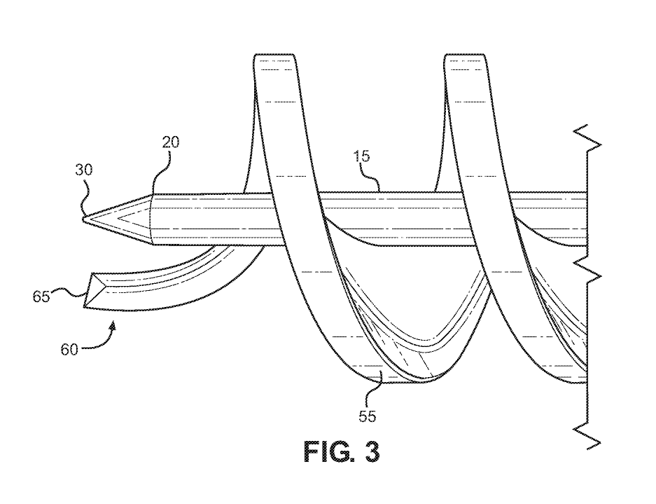

Referring now to FIG. 3, there is shown a close-up view of the pointed end of the helical thread. The helical thread 55 comprises a pointed end 60 having a spur 65, whereby the spur 65 extends in parallel and in the same linear direction as the pointed tip 30 of the elongated rod 15. The spur 65 terminates at the same distance relative to the first end as does the pointed tip 30, such that the spur 65 is symmetrically aligned with the pointed tip 30 as well as oriented in the same direction as the pointed tip 30. In this way, a user may utilize both the pointed tip 30 of the elongated rod 15 and the pointed end 60 of the helical thread 55 to puncture the food item at two separate locations to facilitate the boring thereof. In one embodiment, the helical thread 55 is a composed of a plastic material, such as polycarbonate or polyvinyl chloride. In another embodiment, the helical thread 55 is composed of a metal, such as stainless steel or aluminum. In yet another embodiment, the helical thread 55 is composed of the same material as the elongated rod 15, wherein the thread 55 and the rod 15 can be integrally formed, such as by injecting molding.

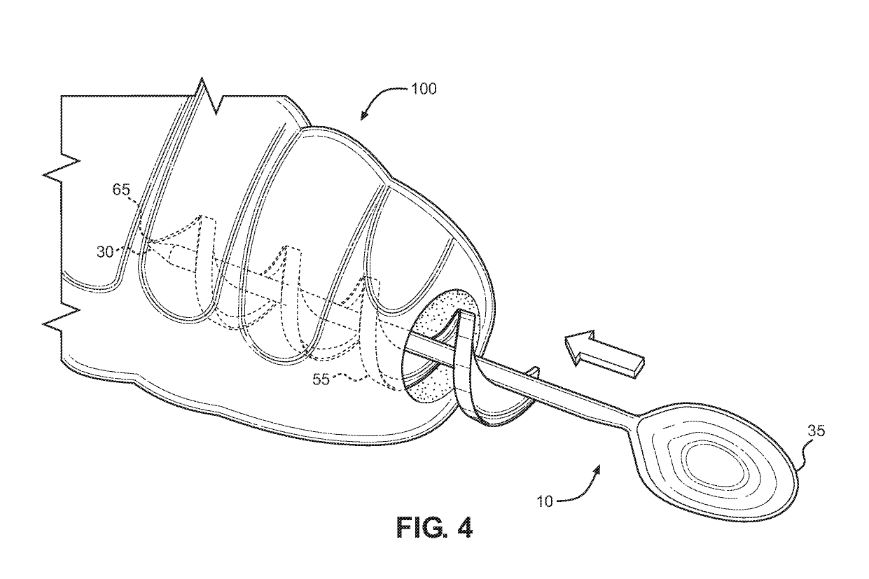

Referring now to FIG. 4, there is shown a view of the bread boring tool in use to bore a hole into a load of bread. In one use, a user utilizes the pointed tip 30 and the spur 65 to puncture holes in a loaf of bread 100. The user then rotates the bread boring tool 10 such that the helical thread 55 bores a hole into the interior of the loaf of bread 100. The user then removes the helical thread 55 and utilizes the scooper 35 to hollow out or enlarge the hole bored by the helical screw 55 as desired. In this way, a user forms a hollowed channel or area within the food item that is fillable with desired ingredients.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A bread boring tool, comprising:
an elongated rod having a first end and a second end;
a pointed tip disposed on the first end;
a scooper disposed on the second end;
a helical thread axially disposed around an exterior of the elongated rod, the helical thread having a spur.

2) The bread boring tool of claim 1, wherein the elongated rod comprises a hollow interior. The bread boring tool of claim 1, wherein the pointed tip comprises a sharpened edge.

4) The bread boring tool of claim 1, wherein the spur of the helical thread extends in parallel and in the same linear direction as does the pointed tip of the elongated rod.

5) The bread boring tool of claim 1, wherein the spur terminates at the same point as the pointed tip of the elongated rod, such that the pointed end is symmetrically aligned and oriented in the same direction as the pointed tip.

6) The bread boring tool of claim 1, wherein the helical thread further comprises a raised edge disposed around a perimeter thereof.

7) The bread boring tool of claim 6, wherein the edge tapers towards the elongated rod.

8) The bread boring tool of claim 1, wherein the elongated rod further comprises a middle portion, wherein the middle portion comprises a grip for grasping the elongated rod.

9) The bread boring tool of claim 8, wherein the grip is composed of a tacky material.
